(19) United States
(12) Patent Application Publication
(10) Pub. No.: US 2020/0213215 A1
(43) Pub. Date: Jul. 2, 2020

(54) ACCESS DEVICE BLOCKCHAIN NETWORK SYSTEMS AND METHODS

(71) Applicant: HEWLETT PACKARD ENTERPRISE DEVELOPMENT LP, Houston, TX (US)

(72) Inventors: Sunil Jayadevappa, Bangalore (IN); Yashavantha Nagaraju, Bangalore (IN); Nitin Singla, Bangalore (IN)

(21) Appl. No.: 16/238,440

(22) Filed: Jan. 2, 2019

(51) Int. Cl. H04L 12/751; H04L 9/32; H04L 29/06; H04L 12/721

(52) U.S. Cl. CPC H04L 45/02; H04L 9/321; H04L 63/0442; H04L 9/3236; H04L 45/12; H04L 2209/38; H04L 63/0876

(57) ABSTRACT

Systems and methods are disclosed in which access devices such as routers and switches form a blockchain network. Each router and switch stores and maintains a local copy of a network topology ledger for which a consensus agreement has been obtained among the routers and switches. The consensus agreement may be based on a validation of one or more fingerprints for one or more blocks of information in the ledger. The fingerprint for each block may be based on information in a preceding block. The network topology ledger includes device identification, routing, and/or other information for device authentication and packet routing by the routers and switches.

### BACKGROUND

An obstacle for migrating many services online is the ability to secure data and verify the identity of users of that service. Currently, online authentication relies on a password, or on rare occasions the use of dual-factor authentication. Open Shortest Path First (OSPF) is a routing protocol for Internet Protocol (IP) networks, which can be configured to authenticate every OSPF message. This is usually done to prevent a rogue router from injecting false routing information and therefore causing a Denial-of-Service attack. However, if a router is compromised, these attacks can be a mechanism to extend the sphere of control of the compromised router by, for example, controlling the link-state advertisements (LSAs) of another router. OSPF attacks work as a force-multiplier to a compromised router. Repeated fight-back attempts may indicate a misconfigured, buggy, or a compromised router in the network. Similar risks and/or issues can arise with the use of border gateway patrol (BGP) authentication.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture suitable for a blockchain network of access devices, according to certain aspects of the disclosure.

FIG. 2 is an architecture illustrating an example access device, server, and networked device from the architecture of FIG. 1, according to certain aspects of the disclosure.

FIG. 3 illustrates a network topology ledger implemented as a blockchain, according to certain aspects of the disclosure.

FIG. 4 illustrates certificates that may be provided for information in a block of the network topology ledger, according to certain aspects of the disclosure.

FIG. 5 is a flow chart illustrating operations for network routing using a blockchain network of access devices, according to certain aspects of the disclosure.

FIG. 6 is a flow chart illustrating operations for generating a network topology ledger, according to certain aspects of the disclosure.

FIG. 7 is a block diagram illustrating an example computer system with which the devices of FIGS. 1 and 2 and the methods of FIGS. 5 and 6 can be implemented.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

The present disclosure addresses various problems arising in computer technology in which large networks with hundreds or thousands of nodes are difficult to manage with standard traditional routing protocols. From the Internet of Things (IoT), to an always-on mobile workforce, organizations face increasingly complex information technology infrastructures from campus to branches. There are a number of problems associated with traditional routing protocols such as OSPF and/or BGP authentication. These problems arise due to needs for neighbors to be in the same area, needs for router identifiers to be unique on neighbors, and lack of design controls (e.g., for neighbors, Hello configurations, passwords, etc.).

OSPF and/or BGP authentication also include security risks, as remote attackers are not inside the routing domain. The authentication is configured on each and every device in the network, however, this becomes cumbersome for the admin and often results in a relatively expensive infrastructure requiring more resources, particularly for a geographically spread network. Moreover, a malicious or hardware or software bug modifying LSAs to MaxAge can lead to network churn traffic, dropped packets, routing table re-computation, and flooding of the LSA.

The systems and methods disclosed here solve the above-noted problems arising in computer technology, introducing a new way of eliminating the OSPF and BGP authentication process by using a blockchain network, resulting in efficient and enhanced security of communications in the network.

In accordance with various aspects of the subject disclosure, access devices such as switches and/or routers (e.g., multiple OSPF and BGP switches) running and deployed in a network are configured to form a blockchain network amongst themselves. In this blockchained network, every access device maintains and stores a common copy of a distributed ledger that contains topology information for the network. The topology information includes routing information, device identifiers (IDs), costs, and/or other OSPF and/or BGP configuration parameters. Before doing any authentication or communication with the neighboring devices, the devices in the network will be adding their information in the Blockchain ledger. All devices, having the same copy of the ledger, will have an agreement that whenever a new particular operation is being performed, the information for the operation is obtained from the ledger copy already residing in their network. Only those operations being permitted in the ledger will be performed for devices with mutual communication.

In accordance with some aspects of the present disclosure, a computer-implemented method is described that includes storing, at a first access device and a plurality of additional access devices, a topology ledger for a network. The topology ledger is based on a consensus agreement between the first access device and the plurality of additional access devices and a signature rule for the topology ledger. The method also includes receiving, at the first access device, a packet from a networked device for transmission on the network. The method also includes determining, with the first access device based on the topology ledger, a route for the packet. The method also includes transmitting the packet from the first access device along the route.

In accordance with some aspects of the present disclosure, a system is disclosed that includes a first access device and a plurality of additional access devices connected to a network, and a networked device connected to the network. The first access device includes a memory storing instructions, and one or more processors. The one or more processors are configured to execute the instructions to store a topology ledger for the network, where the topology ledger is based on a consensus agreement between the first access device and the plurality of additional access devices and a validation rule for the topology ledger, receive a packet from the networked device for transmission on the network, determine, based on the topology ledger, a route for the packet, and transmit the packet from the first access device along the route.

In accordance with some aspects of the present disclosure, a computer-implemented method is disclosed that includes storing, at each of a plurality of access devices connected to a network, validation rules for validating blocks of a network topology ledger. The method also includes receiving, at each of the access devices, information associated with networked devices that are connected to the network. The method also includes adding, with each of at least some of the access devices, portions of the information received at that access device to one or more blocks, each block including a fingerprint generated according to the validation rules. The method also includes obtaining, with at least some of the access devices, a consensus agreement for including each of the one or more blocks in the network topology ledger. The method also includes responsive to the consensus agreement, including each block for which the consensus agreement was obtained to the network topology ledger.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### Example System Architecture

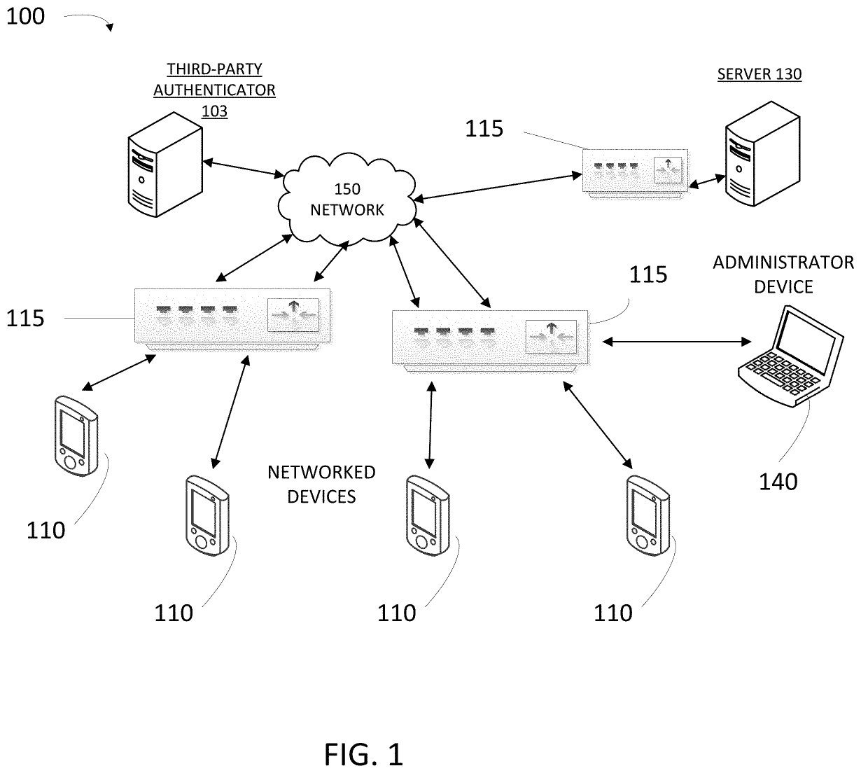

FIG. 1 illustrates an example architecture 100 suitable for implementing a network having a blockchain network of access devices. Architecture 100 includes one or more servers such as server 130 and one or more networked devices 110 connected over a network 150. Access devices 115 such as routers and/or switches manage network access for networked devices and/or server 130. Access devices 115 are each configured to host a memory including instructions which, when executed by a processor, cause the access device to perform at least some of the steps in methods as disclosed herein. In some embodiments, the processor is configured to operate a routing engine running in one or more of access devices 115.

Access devices 115 may be implemented as any device used to handle data communication in a network, (e.g., a node, a switch, a multiplexer, a router, or an access point). In that regard, access devices 115 may include any one of a wired terminal (e.g., a copper cable, a fiber optic cable), or a wireless and/or Internet of Things (IoT) terminal (e.g., Wi-Fi, Bluetooth, Zigbee, cellular network, and the like), or any combination thereof. Access devices 115 may be implemented as instant access points (IAPs) that can act as virtual controllers, routers, hubs, network switches, wireless controllers, and the like.

Networked devices 110 may include a laptop, desktop, IoT device, mobile device, gaming device, printer, or any other computer device configured for electronic communications over a network. An administrator for network 150 may use an administrator device 140 to provide and/or control settings such as blockchain or validation parameters stored at access devices 115.

Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

Access devices 115 are configured as a blockchain network. In this system, each access device 115 maintains a consensus copy of a topology ledger (e.g., a blockchain) for the network, including device identifiers and routing information for the current network topology. When a packet is received from a networked device 110 or server 130 at an access device 115, the access device 115 consults its own copy of the topology ledger to determine the route for the packet. The access device 115 can also authenticate the networked device 110 using information in the ledger. Although various examples are described herein in which access devices 115 form a blockchain network, each maintaining a network topology ledger based on consensus with other access devices, it should be appreciated that any other device or devices (e.g., including networked devices 110 and/or server 130) connected to network 150 can form, or be a part of the blockchain network that maintains local copies of a network topology ledger, if desired.

In accordance with some aspects, access devices 115 may perform pre-encryption of identifying information and/or third-party authentication (e.g., using a third-party sever 103) of information before the information is included in the ledger. This creates a more efficient management of routing tables, and reduces CPU, memory, and bandwidth usage, particularly due to the reduction in authentication operations that are performed relative to OSPF or BGP protocols. Access devices 115 each store rules and/or parameters for consensus updates to the topology ledger. These stored validation rules and/or parameters govern updates to the ledger when a node (e.g., a networked device 110) is added or removed from the network and/or when authentication information (e.g., passwords for networked devices) change, and also provide security for the ledger, as the ledger cannot be updated without consensus from the network of access devices 115.

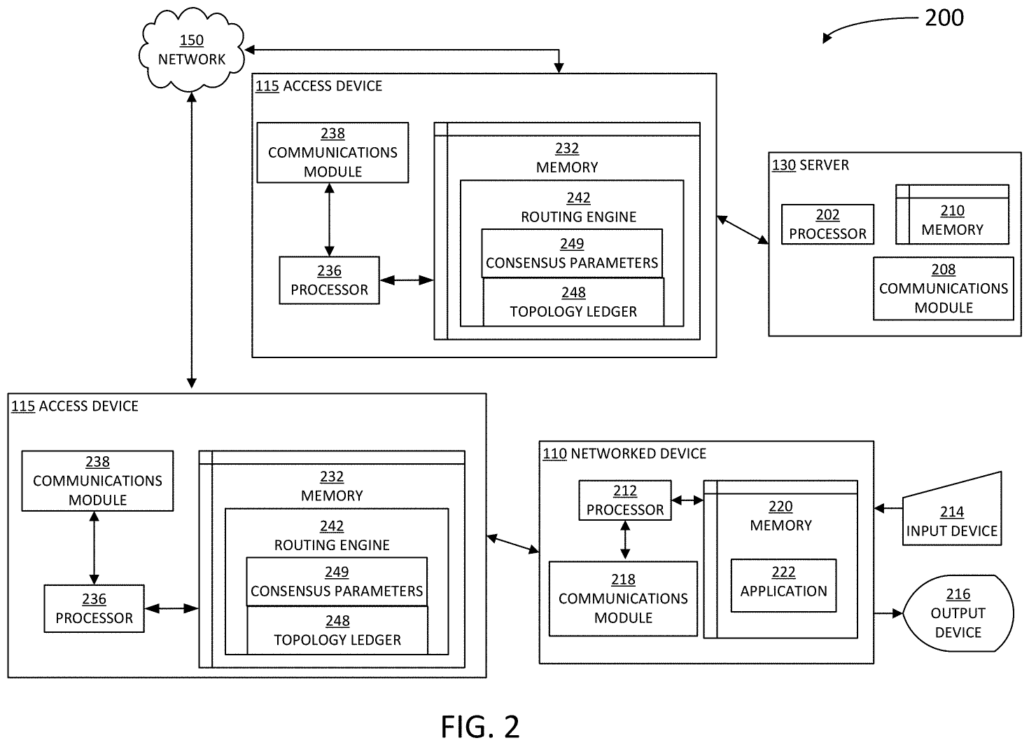

FIG. 2 is a network architecture 200 illustrating an example server 130, networked device 110, and access devices 115 for each in architecture 100 of FIG. 1, according to certain aspects of the disclosure. A plurality of access devices 115 are deployed in a decentralized environment. FIG. 2 shows a simplified representation of such decentralized system for illustration purposes only. Networked device 110 and server 130 are each communicatively coupled to a respective access device 115 via communications modules 208 (server) and 218 (networked device 110). Communications modules 238 of access devices 115 are configured to interface with communications modules 208 and 218 and with network 150 to route packets of information, such as data, requests, responses, and commands to other devices on the network. Communications modules 208, 218, and 238 can include wired communications ports and/or a wireless communication antenna so that networked devices 110 and/or server 130 may locally interact with a corresponding access device through a LAN, or on a device-to-device handshake basis. Networked device 110 may also be coupled with an input device 214 and an output device 216. Input device 214 may include a mouse, a keyboard, a touchscreen, and the like. Output device 216 may include a display, a touchscreen, a microphone, and the like. In some embodiments, input device 214 and output device 216 may be included in the same unit (e.g., a touchscreen) or may be omitted.

As shown in FIG. 2, each access device 115 includes a memory 232, a processor 236, and communications module 238. Processor 236 is configured to execute instructions, such as instructions physically coded into processor 236, instructions stored in memory 232, or a combination of both. Networked device 110 also includes a memory 220 storing instructions to be executed by processor 212, such as an application 222. Server 130 also includes a processor 202 and a memory 210 storing instructions to be executed by processor 202, and other data. In some embodiments, access device 115 also include resources to handle networking operations within a LAN, WLAN, Bluetooth and the like, provided by access device 115. Resources may include hardware and software components, such as input/output ports, network interface circuits (NICs), serializer-deserializer (SERDES) circuits, multiplexer-demultiplexer (MUX-DEMUX) circuits, radio frequency (RF) antennas and controller circuits, and the like.

Memory 232 includes a routing engine 242 configured to manage routing of communications and/or authentication of devices connected to network 150. As shown, routing engine 242 may store a network topology ledger 248 for the devices and/or servers connected to network 150. Routing engine 242 may also store consensus parameters 249 (e.g., validation parameters) that govern operations for updating the topology ledger 248 based on a consensus agreement with other access devices 115 and/or parameters that govern the level of encryption and/or authentication for information within topology ledger 248 and/or for some or all of topology ledger 248 itself.

In one example operational scenario, a first access device 115 and a plurality of additional access devices 115 each store a topology ledger 248, wherein the topology ledger is based on a consensus agreement between the first access device 115 and the plurality of additional access devices 115. Each access device 115 also stores validation rules for the topology ledger. The validation rules may be included in the consensus parameters 249 stored at that access device. The validation rules may be used by an access devices 115 to generate a fingerprint for a new block of information to be added to the network topology ledger, and by the other access devices 115 to validate and approve the new block for addition to the network topology ledger. The consensus parameters may be set by an administrator (e.g., using administrator device 140 of FIG. 1). The first access device 115 may receive a packet from a networked device 110 for transmission on the network 150. The first access device 115 may determine, based on the topology ledger 248 stored at that access device, a route for the packet (e.g., a route to server 130 or to another networked device). The first access device may then transmit the packet from the first access device along the route.

The topology ledger 248 is maintained and stored individually at each access device, but only updated based on a consensus agreement between the access devices. In this way, the same copy of the ledger 248 may be individually maintained at each access device, without the need for a central authority to distribute the ledger (which could create a single-point security weakness that, if breached, could extend to the entire network). The topology ledger 248 may include routing information for routing packets through the network, cost information for the routing information, device identifiers for the networked devices 110 and/or servers that are connected to the network, and/or other information for routing and authenticating information for the network. As described in further detail hereinafter, the device identifiers that are stored in the network topology ledger 248 may be encrypted device identifiers and/or third-party authenticated device identifiers.

In some scenarios, a networked device 110 that sends a packet to an access device for routing through the network may be authenticated, prior to routing the packet (e.g., using a third-party authenticated, encrypted device identifier that is stored in topology ledger 248, and without the use of a password for the device).

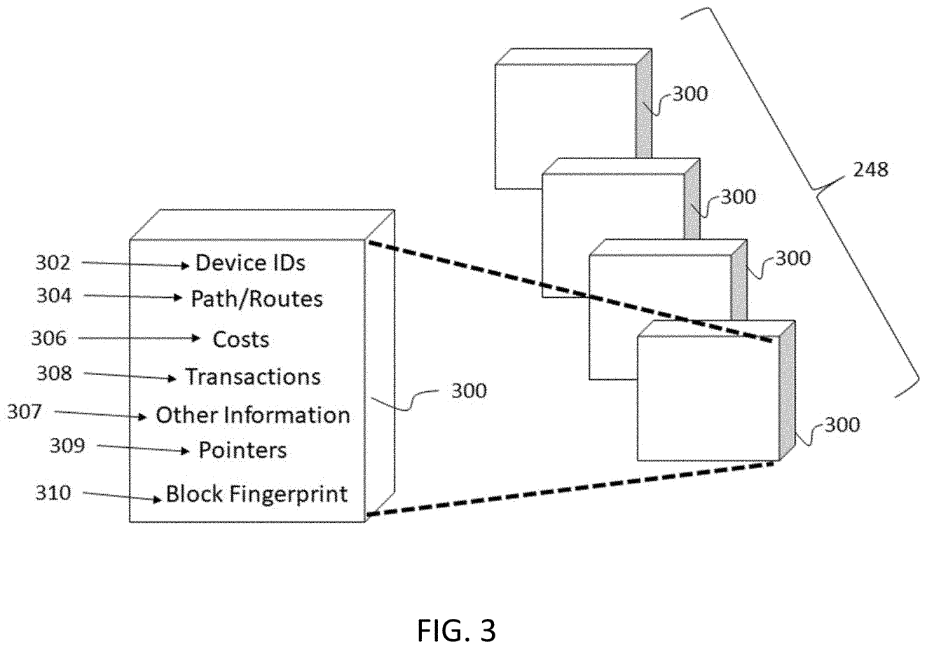

In accordance with various aspects of the disclosure, network topology ledger 248 may be a blockchain. FIG. 3 illustrates an example in which network topology ledger 248 is implemented as a blockchain. As shown, network topology ledger 248 may be include a plurality of blocks 300. Each block 300 may include information associated with the topology of the network of networked devices, access devices, servers, etc. at a given time. Later blocks 300 in the chain that forms network topology ledger 248 include information about the network topology at a later time, which may include updates to information in earlier blocks and/or new information (e.g., for a new device connected to the network).

As shown, the network topology information included in each block 300 may include device identifiers (IDs) 302, path and/or route information 304 (e.g., paths or routes between networked devices 110, access devices 115, servers 130, etc.), cost information 306 or other metrics for each path/route 304, and/or transaction information 308 (e.g., records of devices being added to the network and/or removed from the network, records of passwords and/or password changes for devices, records of route changes, and/or any other information associated with changes to the network). Device identifiers 302 may be clear-text, encrypted, and/or third-party authenticated identifiers and may include information such as device addresses, encryption keys, and/or passwords for one or more devices. Other network topology information that can be stored in network topology ledger 248 may include final destination information, next station information, network interface information, and/or any other information that describes the network topology, routes, devices, and/or authentication information for devices and/or communications. One or more of blocks 300 may include one or more pointers 309 or other references to network topology information stored in other blocks 300.

As shown, each block 300 includes a fingerprint 310. The fingerprint 310 of each block is generated based on validation rules that are known by (e.g., stored at or accessible by) each of access devices 115. For example, the fingerprint 310 of each block may include or be based on information associated with a previous block 300, such that the blocks 300 form a blockchain. The information associated with the previous block may be, for example, a cryptographic hash of the previous block, such that the blockchain provides security against modifications to the topology ledger without the consensus of the network of access devices 115. In this example, the cryptographic hash of the previous block may serve as the fingerprint 310 for the current block. However, it should be appreciated that other fingerprints 310 can be used so long as the fingerprints are generated using validation rules that are known to and common to all access devices 115.

In this way, a distributed network topology ledger 248 is provided that prevents tampering and revision, which facilitates confirmation of the authenticity and security of every transaction recorded on the chain (e.g., without the password and/or other authentication operations that may be required in a standard OSPF or BGP system). In some scenarios, network topology ledger 248 may be also be provided to and/or maintained by other devices on the network such as server 130, and/or some or all of networked devices 110.

By implementing network topology ledger 248 as a chain of blocks 300 as described herein, the network topology ledger 248 is provided with a resistance to modification of the data, which provides providing enhanced security for OSPF services. In this way, a permanent reduction or elimination of issues associated with eavesdropping (e.g., man-in-the-middle), block hole, delay, loop, partition, congestion, and/or delayed or failed convergence of routing tables can be provided. Moreover, the integrity of ledger 248 is continuously being verified by the entire network of access devices, as opposed to a central entity such as a MD5 or SHA1 authentication authority. In this way, the need for network users to trust a central entity is removed or reduced by the strength and computing power of the entire network of access devices.

Since all the (e.g., OSPF) devices store and maintain a single distributed ledger having information about the device and the corresponding information in the network, conflicts and issues for multiple clients at the same time are reduced or eliminated, even if one of the nodes goes down. This improvement can be particularly useful in facilitating scaling existing network designs.

Although blocks 300 are generally described herein as storing only network topology information, it should be appreciated that some blocks may store other information 307 that is unrelated to the network or the network topology. For example, in some implementations, network topology ledger 248 may be integrated into an existing blockchain network. In this example, some of blocks 300 include other information 307 associated with the existing blockchain network, and network topology ledger 248 is formed by blocks 300 that are added to the existing blockchain at various locations and that store network topology information such as device IDs 302, paths/routes 304, costs 306, transactions 308 and/or pointers 309 as described herein. In this regard, it should also be appreciated that some of blocks 300 may store other information 307 without network topology information other than pointers 309 referencing network topology information in other blocks, and/or some of blocks 300 may be free of any network topology information and may store only other information 307 that is unrelated to the network topology.

As noted above, in some implementations, prior to inclusion in a block of network topology ledger 248, identities of data and and/or entities or devices may be signed and/or authenticated (e.g., linked to their public keys in a key-pair arrangement). Signature and/or authentication of information for ledger 248 may be specified by consensus parameters 249, or may be performed as desired by one or more devices (e.g., as a separate overlay protocol).

In one suitable example, prior to inclusion in a block of network topology ledger 248 (e.g., particularly for identity-related attributes like serial number, MAC or IP address, finger-print, or other device information), information for inclusion in the block may be stored in the form of hashes, which can be used (e.g., in combination with a private key for the device) to generate a signature to be included in the block with the information. The information, the hashes, and/or the signatures can be stored in the ledger, as desired.

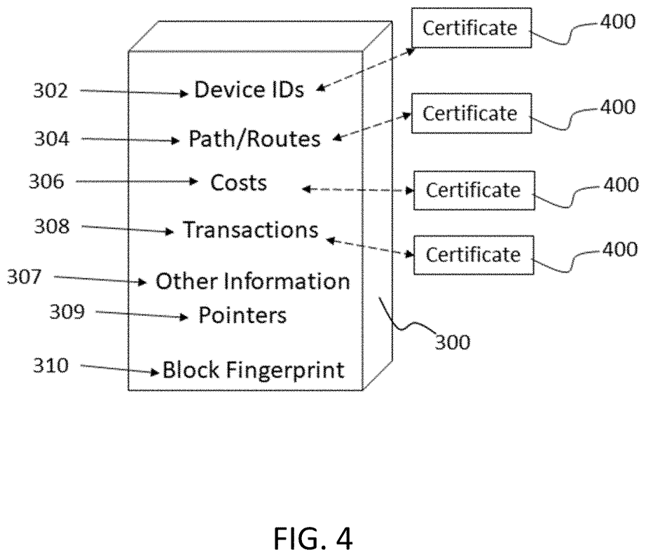

Additionally, if desired and as indicated in FIG. 4, the information can be certified by a recognized party such as third-party server 103 of FIG. 1 (e.g., a notary server). For example, a certificate 400 may be obtained for any information in block 300, for block fingerprint 310, and/or for block 300 itself, as desired. Subsequently, upon retrieving information from the ledger 248, a device can use the hash to verify the integrity of the data, the signature to verify the origin of the data, and/or the certificate (and the third party) to verify the hashes by authenticating that the information provided on the blockchain is true. In this way, whenever a device's identity is needed for any kind of authentication or identification mechanism, the hashes of the block pre-verified by the trusted recognized party can be used.

By operating the access devices 115 according to the consensus parameters 249 and the validation rules, issues arising as result of merge and split scenarios or during connectivity, problems can be avoided.

Before performing any new OSPF or BGP operation, a device connected to network 150 checks network topology ledger 248 for the network. More specifically, the device checks ledger 248 for the required parameters and which device has the credentials and where the packet is to be routed. The current network topology ledger 248 may be maintained by each of access devices 115 and may be distributed to all nodes in the network. Because the devices check the updated, current network topology ledger 248 in this way, the convergence time for the OSPF protocol can be reduced, resulting in a better (e.g., more efficient) device performance. Use of network topology ledger 248 in this way may also help save memory and CPU utilization of the device as a result of reduced OSPF and BGP operations.

Further advantages of the use of a network of access devices 115 maintaining and operating based on a consensus network topology ledger include fast and secure OSPF convergence without needing to configure OSPF or BGP authentication in every networking device, scalability to larger networks, reducing or eliminating the need to separately and individually enable authentication for the respective protocol on all the devices in the network, and/or elimination of the OSPF or BGP authentication mechanism.

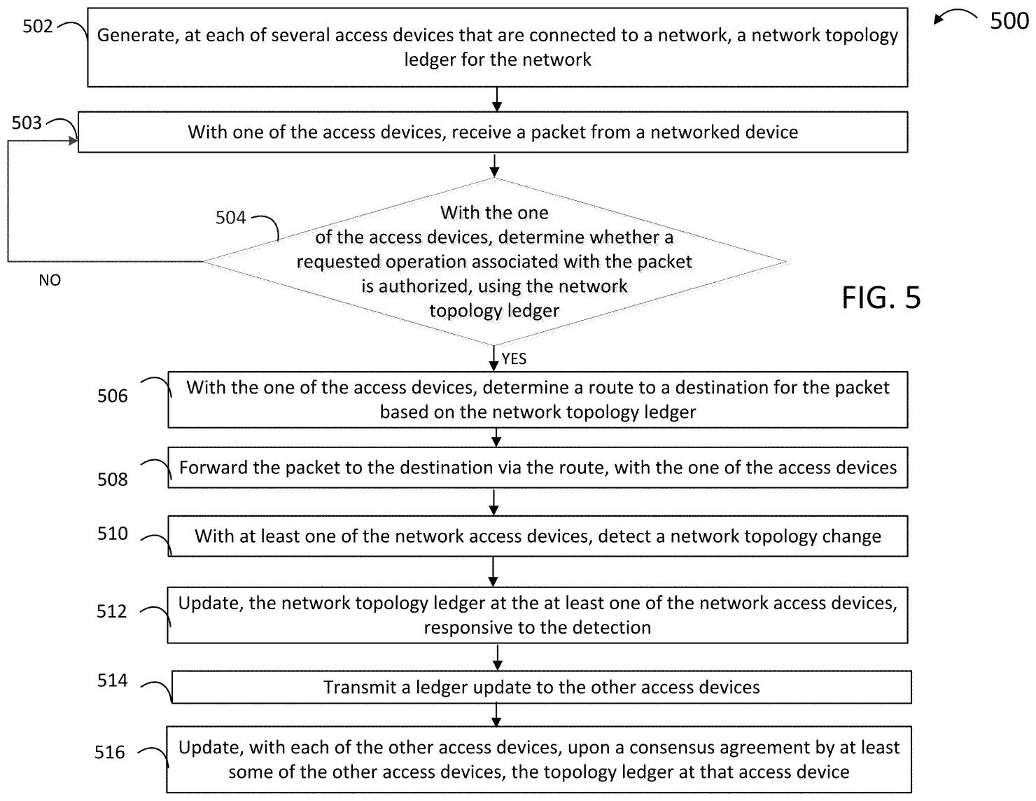

FIG. 5 is a flow chart illustrating operations in a method 500 for operating a network of access devices using a consensus network topology ledger, according to some embodiments. Method 500 may be performed at least partially by any one of access devices 115, while communicating with one or more of a plurality of other access devices 115, server 130, networked devices 110, and/or third-party servers 103. The access device may be hosting a routing engine configured to forward packets along routes in a network. At least some of the steps in method 500 may be performed by a computer having a processor executing commands stored in a memory of the computer (e.g., processors 236, memories 232). Methods consistent with the present disclosure may include at least some, but not all, of the operations illustrated in method 500, performed in a different sequence. Furthermore, methods consistent with the present disclosure may include at least two or more operations as in method 500 performed overlapping in time, or almost simultaneously.

At block 502, at each of several access devices such as access devices 115 that are connected to a network such as network 150, a network topology ledger 248 for the network may be generated.

At block 503, with one of the access devices, a packet is received from a networked device such as networked device 110.

At block 504, with the one of the access devices 115, it may be determined whether a requested operation associated with the packet is authorized, using the network topology ledger 248.

At block 506, with the one of the access devices and if the requested operation is authorized, a route to a destination for the packet is determined based on the network topology ledger 248 (e.g., by retrieving the route from the ledger).

At block 508, the packet is forwarded to the destination via the route (e.g., by forwarding the packet to a next hop on the route) with the one of the access devices. The one of the access devices may repeat the operations of block 503, 504, 506, and/or 508 anytime a packet is received.

At block 510, with at least one of the network access devices, a network topology change is detected. For example, one or more networked devices may join the network, one or more networked devices may disconnect from the network, one or more device passwords or addresses may change, etc.

At block 512, the network topology ledger is updated at the at least one of the network access devices, responsive to the detection. For example, the at least one of the network access devices may add information associated with the network topology change to a new block for the ledger and generate a fingerprint for the ledger based on the validation rules. The fingerprint may be based on (e.g., a hash of) the contents of a preceding block.

At block 514, a ledger update (e.g., the new block and the associated fingerprint) is transmitted to the other access devices 115.

At block 516, with each of the other access devices, upon a consensus agreement by at least some of the other access devices (e.g., an agreement that the fingerprint is valid according to the validation rules), the topology ledger at that access device is updated.

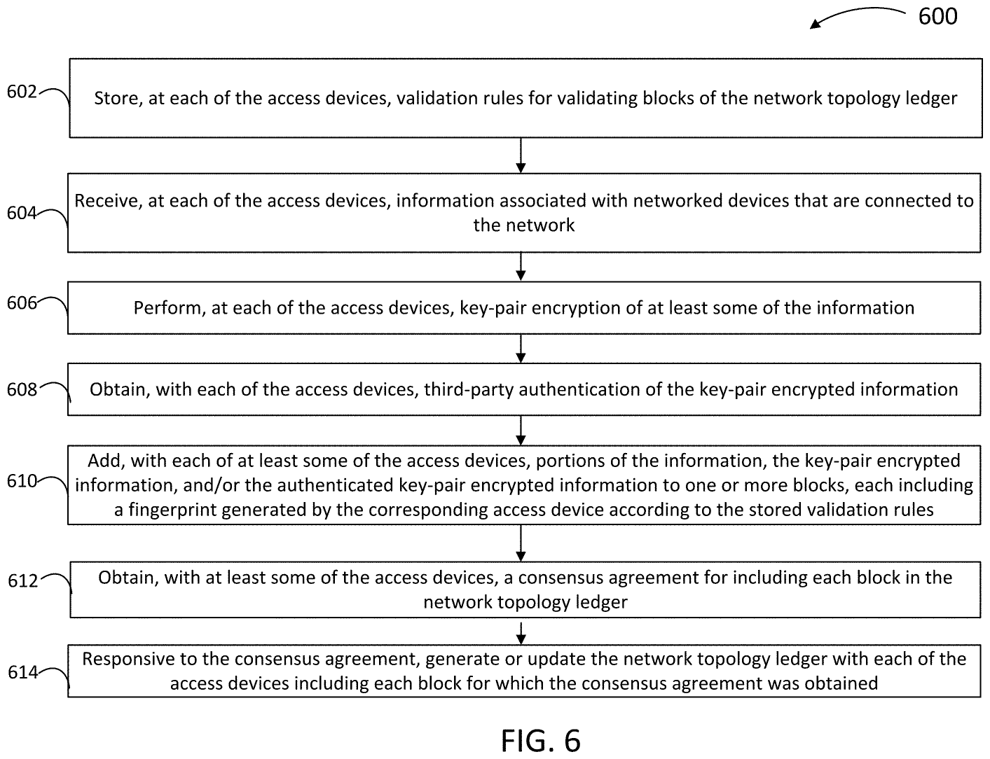

FIG. 6 is a flow chart illustrating operations in a method 600 for generating a network topology ledger as described at block 502 of FIG. 5. Methods consistent with the present disclosure may include at least some, but not all, of the steps illustrated in method 600, performed in a different sequence. Furthermore, methods consistent with the present disclosure may include at least two or more steps as in method 600 performed overlapping in time, or almost simultaneously.

At block 602, at each of the access devices 115, validation rules for validating blocks of the network topology ledger may be stored. The validation rules may include consensus parameters and/or other information for validating updates to ledger 248 (e.g., for generating and/or validating block fingerprints).

At block 604, at each of the access devices 115, information associated with networked devices that are connected to the network may be received. For example, each access device 115 may receive device identifying information, device authenticating information, and/or device feature information from the networked devices 110 locally connected (e.g., via wired or wireless connection) to that access device.

At block 606, each of the access devices may (optionally) perform key-pair encryption of at least some of the information.

At block 608, each of the access devices may obtain third-party authentication of the key-pair encrypted information (e.g., a certificate 400 from third-party server 103).

At block 610, with each of at least some of the access devices, portions of the information, the key-pair encrypted information, and/or the authenticated key-pair encrypted information are added to one or more blocks, each block including a fingerprint generated by the corresponding access device according to the stored validation rules.

At block 612, with at least some of the access devices 115, a consensus agreement (e.g., based on the validation rules) may be obtained for including each block in the network topology ledger 248.

At block 614, responsive to the consensus agreement, the network topology ledger may be generated (e.g., for a primary block) or updated (e.g., for all other blocks) with each of the access devices including each block for which the consensus agreement was obtained.

### Hardware Overview

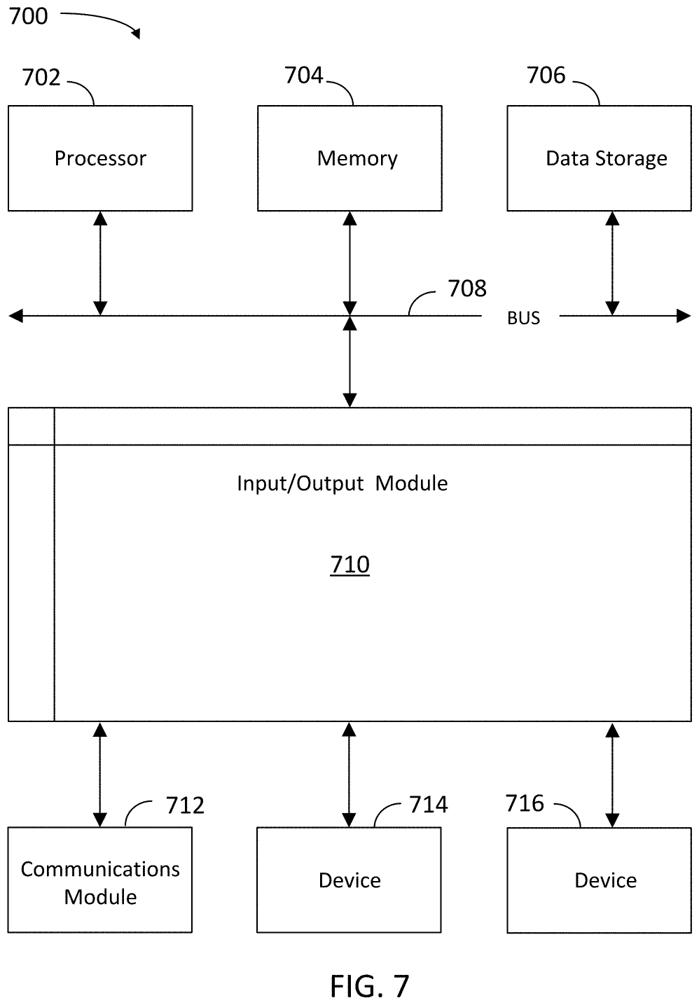

FIG. 7 is a block diagram illustrating an exemplary computer system 700 with which the access device 115, networked device 110, and server 130 of FIGS. 1 and 2, and the methods of FIGS. 5 and 6, can be implemented. In certain aspects, the computer system 700 may be implemented using hardware or a combination of software and hardware, either in a dedicated network device, or integrated into another entity, or distributed across multiple entities.

Computer system 700 (e.g., access device 115, networked device 110 and/or server 130) includes a bus 708 or other communication mechanism for communicating information, and a processor 702 (e.g., processors 212 and 236) coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memories 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, e.g., one or more modules of computer program instructions encoded on a computer readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage 706 such as a magnetic disk or optical disk, coupled to bus 708 for storing information and instructions. Computer system 700 may be coupled via input/output module 710 to various devices. Input/output module 710 can be any input/output module. Exemplary input/output modules 710 include data ports such as USB ports. The input/output module 710 is configured to connect to a communications module 712. Exemplary communications modules 712 (e.g., communications modules 218 and 238) include networking interface cards, such as Ethernet cards and modems. In certain aspects, input/output module 710 is configured to connect to a plurality of devices, such as an input device 714 (e.g., input device 214) and/or an output device 716 (e.g., output device 216). Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 716 include display devices, such as an LCD (liquid crystal display) monitor, for displaying information to the user.

According to one aspect of the present disclosure, the access device 115, networked device 110, and server 130 can be implemented using a computer system 700 in response to processor 702 executing one or more sequences of one or more instructions contained in memory 704. Such instructions may be read into memory 704 from another machine-readable medium, such as data storage 706. Execution of the sequences of instructions contained in main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data network device, or that includes a middleware component, e.g., an application network device, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and network devices. A client and network device are generally remote from each other and typically interact through a communication network. The relationship of client and network device arises by virtue of computer programs running on the respective computers and having a client-network device relationship to each other. Computer system 700 can be, for example, and without limitation, a desktop computer, laptop computer, or tablet computer. Computer system 700 can also be embedded in another device, for example, and without limitation, a switch, a router, a node, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage 706. Volatile media include dynamic memory, such as memory 704. Transmission media include coaxial cables, copper wire, and fiber optics, including the wires forming bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising:
storing, at a first access device and a plurality of additional access devices, a topology ledger for a network, wherein the topology ledger is based on a consensus agreement between the first access device and the plurality of additional access devices and a validation rule for the topology ledger;
receiving, at the first access device, a packet from a networked device for transmission on the network;
determining, with the first access device based on the topology ledger, a route for the packet; and
transmitting the packet from the first access device along the route.

2. The computer-implemented method of claim 1, wherein the topology ledger comprises routing information for routing packets through the network.

3. The computer-implemented method of claim 2, wherein the topology ledger includes cost information for the routing information.

4. The computer-implemented method of claim 3 wherein the topology ledger further comprises a device identifier for the networked device.

5. The computer-implemented method of claim 4, wherein the device identifier is an encrypted device identifier.

6. The computer-implemented method of claim 5, wherein the encrypted device identifier is a third-party authenticated, encrypted device identifier.

7. The computer-implemented method of claim 1, further comprising authenticating the networked device, using the topology ledger and without accessing a password for the networked device.

8. The computer-implemented method of claim 1, wherein the topology ledger includes network topology information that is stored in a plurality of blocks, each having a fingerprint that is based on a preceding block.

9. The computer-implemented method of claim 1, wherein the first access device is a switch.

10. The computer-implemented method of claim 1, wherein the first access device is a router.

11. The computer-implemented method of claim 1, wherein the networked device is an IoT device.

12. The computer-implemented method of claim 1, wherein the topology ledger comprises a blockchain.

13. A system, comprising:
a first access device and a plurality of additional access devices connected to a network; and
a networked device connected to the network, wherein the first access device comprises:
a memory storing instructions; and
one or more processors configured to execute the instructions to:
store a topology ledger for the network, wherein the topology ledger is based on a consensus agreement between the first access device and the plurality of additional access devices and a validation rule for the topology ledger;
receive a packet from the networked device for transmission on the network;
determine, based on the topology ledger, a route for the packet; and
transmit the packet from the first access device along the route.

14. The system of claim 13, wherein one or more processors are further configured to execute the instructions to detect a network topology change associated with the network.

15. The system of claim 14, wherein one or more processors are further configured to execute the instructions to generate an update to the topology ledger at the first access device based on the network topology change.

16. The system of claim 15, wherein one or more processors are further configured to execute the instructions to obtain a consensus agreement from at least some of the plurality of additional access devices for the update to the topology ledger.

17. A computer-implemented method, comprising:
storing, at each of a plurality of access devices connected to a network, validation rules for validating blocks of a network topology ledger;
receiving, at each of the access devices, information associated with networked devices that are connected to the network;
adding, with each of at least some of the access devices, portions of the information received at that access device to one or more blocks, each block including a fingerprint generated according to the validation rules;
obtaining, with at least some of the access devices, a consensus agreement for including each of the one or more blocks in the network topology ledger; and
responsive to the consensus agreement, including each block for which the consensus agreement was obtained to the network topology ledger.

18. The computer-implemented method of claim 17, wherein the fingerprint for each block is based on information associated with at least one other block.

19. The computer-implemented method of claim 18, wherein the information associated with at least one other block comprises a hash of contents of a preceding block.

20. The computer-implemented method of claim 17, further comprising:
performing a key-pair encryption of at least some of the information; and
obtaining a third-party authentication of the key-pair encrypted information.
